(19) United States
(12) Patent Application Publication
(10) Pub. No.: US 2004/0158707 A1
(43) Pub. Date: Aug. 12, 2004

(54) Mobile terminal for use restriction and copyright protection for content, and content security system using the same

(75) Inventor: Young-Hyun Kim, Seoul (KR)

Correspondence Address: Paul J. Farrell, DILWORTH & BARRESE, LLP, 333 Earle Ovington Blvd., Uniondale, NY, 11553, US

(73) Assignee: SAMSUNG ELECTRONICS CO., LTD., GYEONGGI-DO (KR)

(21) Appl. No.: 10/774,560

(22) Filed: Feb. 9, 2004

(30) Foreign Application Priority Data
Feb. 10, 2003 (KR) 2003-8251

(51) Int. Cl. H04L 9/00

(52) U.S. Cl. 713/153

(57) ABSTRACT

A mobile terminal accesses a content server by wired and/or wireless communication, downloads content from the content server, and uploads the downloaded content to an external device. A memory stores model information and a serial number of the mobile terminal and the downloaded content, and also stores an encryption key for encrypting the content downloaded from the external device. A communication unit provides an interface for exchanging data with the external device. An encryption unit encrypts the serial number and the content with the encryption key. A controller uploads the encrypted content to the external device via the communication unit, and transmits a download request signal for the uploaded content to the external device in response to an input command. A decryption unit decrypts, with the encryption key, the content downloaded from the external device in response to the download request signal for the uploaded content.

### PRIORITY

This application claims priority under 35 U.S.C. § 119 to an application entitled “Communication Terminal for Protecting Copyright and Restricting Using of Contents and Contents Security System Using That” filed in the Korean Industrial Property Office on Feb. 10, 2003 and assigned Serial No. 2003-8251, the contents of which are incorporated herein by reference.

### BACKGROUND OF THE INVENTION

1. Field of the Invention

The present invention relates generally to a mobile communication terminal for downloading and uploading content, and in particular, to a mobile communication terminal capable of downloading and uploading content while maintaining security for the content.

2. Description of the Related Art

Lately, mobile communication terminals (hereinafter referred to as “mobile terminals”) can download various content such as games, music appreciation and Karaoke applications, and images, and provide users with various functions using the downloaded content. The existing mobile terminal supports only a one-way data communication technique in which the mobile terminal can only download stored content into a computer through data communication. In general, a user of the mobile terminal should pay a prescribed amount of money to a service provider who manages a content server, in order to access the content server and download desired content from the content server. If the user wishes to save money, he or she may download free content through data communication. In terms of quality, however, a free content service is inferior to a pay content service.

In the case where a mobile terminal has no room to store the content downloaded using a pay content service, a user of the mobile terminal must delete the previously downloaded paid content before downloading new content into the mobile terminal using the pay content service. The existing pay content services only provide a function of allowing the user to download paid content from a content server, and do not provide a function of allowing the user to upload the previously downloaded content into the content server when necessary.

In addition, the existing mobile terminal connects to a computer through an interface such as a PC (Personal Computer) link to provide a function of downloading the content selected by the user from the computer. However, in the case where it is possible to transmit the content stored in the mobile terminal to the computer, other mobile terminals can also download the content stored in the computer, so a copyright on the paid content cannot be protected.

### SUMMARY OF THE INVENTION

It is, therefore, an object of the present invention to provide a mobile terminal capable of restricting a right to use paid content when downloading and uploading the paid content downloaded with a pay content service, from/to a computer, and a content security system using the same.

It is another object of the present invention to provide a mobile terminal capable of protecting a copyright on paid content by preventing the paid content from being transmitted from a computer to another mobile terminal, and a content security system using the same.

To achieve the above and other objects, there is provided a mobile terminal for accessing a content server by wired and/or wireless communication, downloading content from the content server, and uploading the downloaded content to an external device. The mobile terminal comprises a memory for storing model information and a serial number of the mobile terminal and the downloaded content, and also for storing an encryption key for encrypting the content downloaded from the external device; a communication unit for providing an interface for exchanging data with the external device; an encryption unit for encrypting the serial number and the content with the encryption key; a controller for uploading the encrypted content to the external device via the communication unit, and transmitting a download request signal for the uploaded content to the external device in response to an input command; and a decryption unit for decrypting, with the encryption key, the content downloaded from the external device in response to the download request signal for the uploaded content.

Preferably, the encryption key is generated by the external device based on the model information and the serial number of the mobile terminal.

As a further embodiment, there is provided a content security system including a mobile terminal and an external memory device. The mobile terminal encrypts content provided from a content server with an encryption key provided from an external device, and uploads the encrypted content to the external device. The external memory device generates the encryption key based on model information and a serial number of the mobile terminal, and stores the encrypted content uploaded from the mobile terminal.

Preferably, the external memory device generates the encryption key considering further time information set in the external memory device. In addition, the external memory device determines whether the time information set in the external memory device is identical to time information set in the mobile terminal, and generates the encryption key if the time information set in the external memory device is identical to time information set in the mobile terminal.

The mobile terminal transmits a download request signal for previously uploaded content to the external memory device in response to an input command, and decrypts, with the encryption key, content downloaded from the external memory device in response to the download request signal.

As a further embodiment, there is provided a content protection method using a content security system having a mobile terminal for downloading content from a content server and an external memory device for storing the content at a request of the mobile terminal. The method comprises transmitting a content upload request signal to the external memory device in response to an input command; transmitting to the external memory device model information and a serial number of the mobile terminal, requested by the external memory device in response to the content upload request signal; encrypting content to be uploaded with an encryption key generated by the external memory device based on the model information and the serial number; and transmitting the content encrypted by the encryption key to the external memory device.

Preferably, the method further comprises determining whether the encrypted content uploaded from the mobile terminal is identical to the content encrypted by the encryption key; and storing the encrypted content in the external memory device if the encrypted content uploaded from the mobile terminal is identical to the content encrypted by the encryption key. In addition, the method further comprises the steps of: upon receiving a download command for the previously uploaded content, transmitting a content download request signal to the external memory device; if content index information for downloading is selected from content index information provided from the external memory device in response to the content download request signal, transmitting the selected content index information to the external memory device; if encrypted content is downloaded from the external memory device according to the selected content index information, decrypting the downloaded encrypted content with the encryption key.

Preferably, the encryption key is generated by the external memory device considering further time information set in the external memory device. In addition, the encryption key is generated when time information set in the external memory device is identical to time information set in the mobile terminal.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a general structure of a communication system for downloading and uploading paid content using a mobile terminal;

FIG. 2 is a block diagram illustrating a content security system for protecting a copyright on content according to an embodiment of the present invention;

FIG. 3 is a flowchart illustrating a content protection method using a content security system according to an embodiment of the present invention; and

FIG. 4 is a flowchart illustrating a procedure for downloading the content uploaded by the procedure of FIG. 3.

### DETAILED DESCRIPTION OF THE PREFERRED EMBODIMENT

Several preferred embodiments of the present invention will now be described in detail with reference to the attached drawings. In the drawings, the same or similar elements are denoted by the same reference numerals even though they are depicted in different drawings. In the following description, a detailed description of known functions and configurations incorporated herein has been omitted for conciseness.

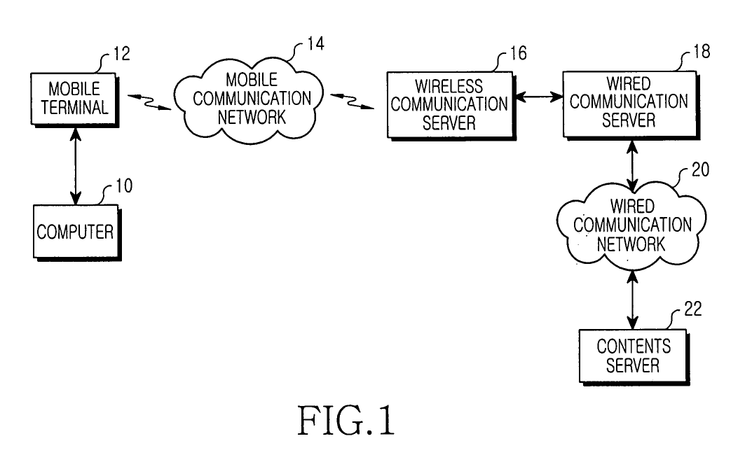

FIG. 1 is a block diagram illustrating a general structure of a communication system for downloading and uploading paid content using a mobile terminal. Referring to FIG. 1, a mobile terminal 12 accesses a content server 22 providing a pay content service in response to an input signal, and transmits a pay content request signal to the content server 22 through a mobile communication network 14 in response to a selected signal. A wireless communication server 16 transmits the pay content request signal provided via the mobile communication network 14 to a wired communication server 18. The wireless communication server 16 controls a communication channel of a particular terminal connected to the mobile communication network 14, for radio communication between them, and provides a signal responsive to an input request command to the corresponding terminal. The wired communication server 18 controls a communication channel of a particular terminal connected to a wired communication network 20, for wired communication between them, and provides a signal responsive to an input request command to the corresponding terminal.

Upon receiving a pay content request signal from the mobile terminal 12, the wired communication server 18 transmits the received pay content request signal to the content server 22 via the wired communication network 20. Upon receiving the pay content request signal, the content server 22 provides content corresponding to the received pay content request signal to the wired communication server 18 via the wired communication network 20 so as to transmit the content to the mobile terminal 12. Upon receiving the content transmitted from the content server 22, the wired communication server 18 transmits the received content to the wireless communication server 16. The wireless communication server 16 transmits the content provided from the wired communication server 18 to the mobile terminal 12 via the mobile communication network 14.

In this manner, the mobile terminal 12 can be provided with the content corresponding to the pay content request signal. The mobile terminal 12 displays the received content on its screen or stores the received content in a memory according to a command previously set and/or input by the user. In addition, the mobile terminal 12 can be connected to a computer 10 via an interface and upload the content stored therein into the computer 10. The computer 10 then stores the content uploaded from the mobile terminal 12 in an auxiliary memory device.

Such a communication system for downloading and uploading content uploads the content stored in the mobile terminal 12 into an external memory such as an auxiliary memory device of the computer 10, contributing to an increase in efficiency of the limited memory capacity of the mobile terminal 12. Nevertheless, the communication system of FIG. 1 cannot guarantee security for the content stored in the computer 10.

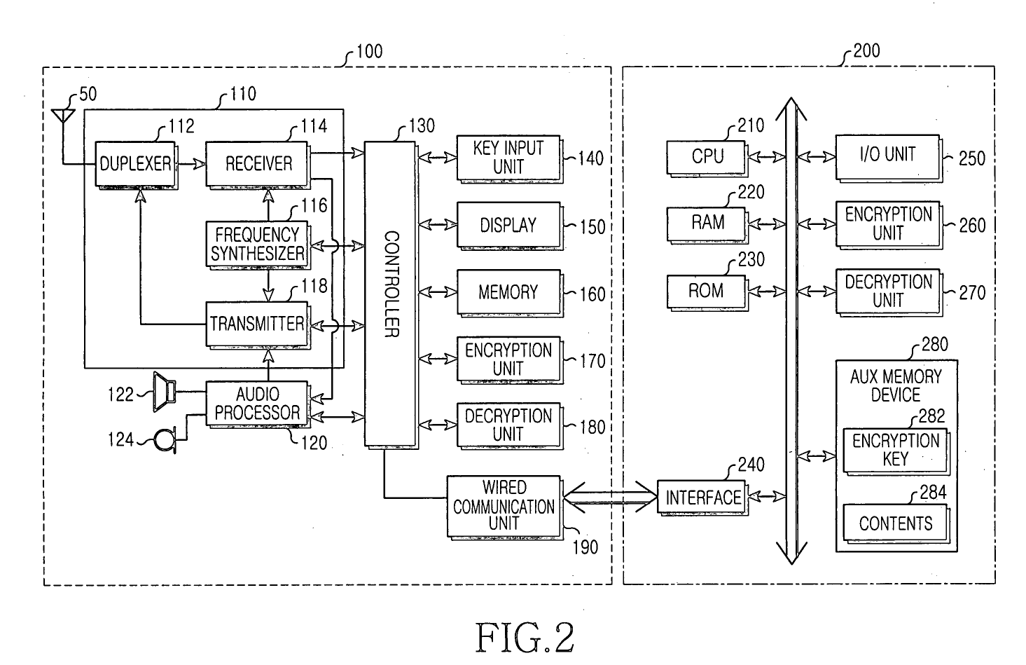

FIG. 2 is a block diagram illustrating a content security system for protecting the copyright on content according to an embodiment of the present invention. As illustrated, the content security system includes a mobile terminal 100 and a computer 200, the computer 200 serving as an external memory device.

The mobile terminal 100 sends a content request to the content server 22 via an antenna 50, stores content provided from the content server 22 in a memory 160, and uploads the content stored in the memory 160 into the computer 200 connected thereto via a wired communication unit 190. The mobile terminal 100 includes a controller 130, a wireless communication unit 110, an audio processor 120, a key input unit 140, a display 150, a memory 160, an encryption unit 170, a decryption unit 180, and the wired communication unit 190.

The controller 130 controls an overall operation of the mobile terminal 100, and particularly controls transmission and reception of a signal for communication with an external device. The wireless communication unit 110 communicates with an external device, and receives data including the content transmitted from the external device. The audio processor 120 decodes a signal output from the wireless communication unit 110, converts the decoded signal into an electric audio (or voice) signal, and outputs the electric audio signal to a speaker 122. Alternatively, the audio processor 120 converts an audio signal picked up by a microphone 124 into an electric audio signal, encodes the electric audio signal, and outputs the coded electric audio signal to a transmitter 118 in the wireless communication unit 110.

The key input unit 140 includes a plurality of numerical keys and character keys, generates key data corresponding to a key selected by the user, and provides the generated key data to the controller 130. The display 150 displays status information and/or operating information of the mobile terminal 100, under the control of the controller 130. The memory 160 permanently stores a control program needed by the controller 130, and temporarily stores data generated during a control operation of the controller 130. In addition, the memory 160 stores content downloaded from the external device. The wired communication unit 190 provides an interface for communication by wire with an external communication device such as the computer 200.

The wireless communication unit 110 includes a duplexer 112, a receiver 114, a frequency synthesizer 116, and a transmitter 118. The duplexer 112 extracts a radio frequency (RF) band signal from the signal received at the antenna 50, and provides the extracted RF band signal to the receiver 114. Alternatively, the duplexer 112 provides a signal output from the transmitter 118 to the antenna 50. The receiver 114, under the control of the controller 130, provides data corresponding to an audio portion of the signal to the audio processor 120, and provides data corresponding to a non-audio portion of the signal to the controller 130.

The frequency synthesizer 116 generates frequencies to be provided to the transmitter 118 and the receiver 114 under the control of the controller 130, and provides the generated frequencies to the transmitter 118 and the receiver 114, respectively. The transmitter 118 converts a signal output from the audio processor 120 and a signal output from the frequency synthesizer 116 into an RF band transmission signal.

The encryption unit 170 encrypts a serial number N of the mobile terminal 100 and the content C stored in the memory 160, using a unique encryption key k provided from the computer 200. The encrypted serial number N(k) and the encrypted content C(k) are transmitted (or uploaded) to the computer 200 via the wired communication unit 190, under the control of the controller 130. The decryption unit 180 decrypts encrypted content C(k) received from the computer 200 via the wired communication unit 190, under the control of the controller 130.

Because the content is encrypted before being uploaded into the external memory device with a unique encryption key provided from the external memory device, only a particular mobile terminal that has uploaded particular content into the external memory device can download the particular content, thereby maintaining security for the content. As a result, it is possible to protect a copyright on the content provided from the content server.

The computer 200 includes a central processing unit (CPU) 210, a random access memory (RAM) 220, a read-only memory (ROM) 230, an interface 240, an input/output unit (I/O) 250, an encryption unit 260, a decryption unit 270, and an auxiliary memory device 280.

The CPU 210 has a logic circuit for handling a program command of the computer 200, controls an overall operation of the computer 200, and processes data corresponding to an input signal. The RAM 220 caches an operating system, an application program and currently used data, in order to allow the CPU 210 of the computer 200 to rapidly access them, when necessary. The ROM 230 is a memory mounted in the computer 200, and can read data stored therein but cannot change the data. The ROM 230 stores a program used when booting or resetting the computer 200.

The interface 240 provides a protocol for exchanging data with an external device. In the embodiment, the interface 240 is connected to the wired communication unit 190 of the mobile terminal 100, and provides a protocol for exchanging data between the mobile terminal 100 and the computer 200. The input/output unit 250 provides the CPU 210 with a signal received from an input device such as a keyboard and a mouse connected to the computer 200, and provides output data to an output device such as a monitor (not shown) connected to the computer 200, under the control of the CPU 210.

The encryption unit 260 generates a unique encryption key k to be provided to the mobile terminal 100, based on model information M and a serial number N of the mobile terminal 100, provided from the mobile terminal 100, and time information T set in the computer 200. The decryption unit 270 decrypts encrypted content C(k) provided from the mobile terminal 100 and checks whether the encrypted content C(k) provided from the mobile terminal 100 were encrypted by the encryption key k provided from the computer 200.

The auxiliary memory device 280 stores the encryption key k (282) generated by the encryption unit 260 and the encrypted content C(k) (284) provided from the computer 200, based on the model information M and the serial number N of the mobile terminal 100, and the time information T set in the computer 200.

If the mobile terminal 100 requests the computer 200 to download the content that the mobile terminal 100 has previously uploaded, the computer 200 provides the content 284 stored in the auxiliary memory device 280 to the mobile terminal 100. In this case, the content provided to the mobile terminal 100 is data that was encrypted with the encryption key k. Upon receiving the encrypted content, the mobile terminal 100 decrypts the content encrypted with the encryption key k that was provided from the computer 200 and stored in the memory 160.

Preferably, the mobile terminal 100 may transmit a content download request signal to the computer 200 along with its model information M and serial number N. The CPU 210 of the computer 200 then determines whether the download-requested content is identical to the content previously uploaded from the mobile terminal 100, based on the model information M and the serial number N of the mobile terminal 100, included in the content download request signal. If it is determined that the download-requested content is identical to the content uploaded from the mobile terminal 100, the CPU 210 transmits the encrypted content 284 stored in the auxiliary memory device 280 to the mobile terminal 100 via the interface 240. Otherwise, if the download-requested content is not identical to the content uploaded from the mobile terminal 100, the CPU 210 does not provide the encrypted content 284 stored in the auxiliary memory device 280 to the mobile terminal 100.

The mobile terminal 100 decrypts the content provided in response to a download request for the uploaded content using the encryption key k used for encryption during content uploading, so the computer 200 can restrict the right to use the corresponding content. In addition, as the content download request signal includes the model information M and the serial number N of the mobile terminal 100, the computer 200 determines whether the download-requested content is identical to the content previously uploaded by the mobile terminal 100, and provides the corresponding content to the mobile terminal 100 only when they are identical to each other, thereby protecting a copyright on the content.

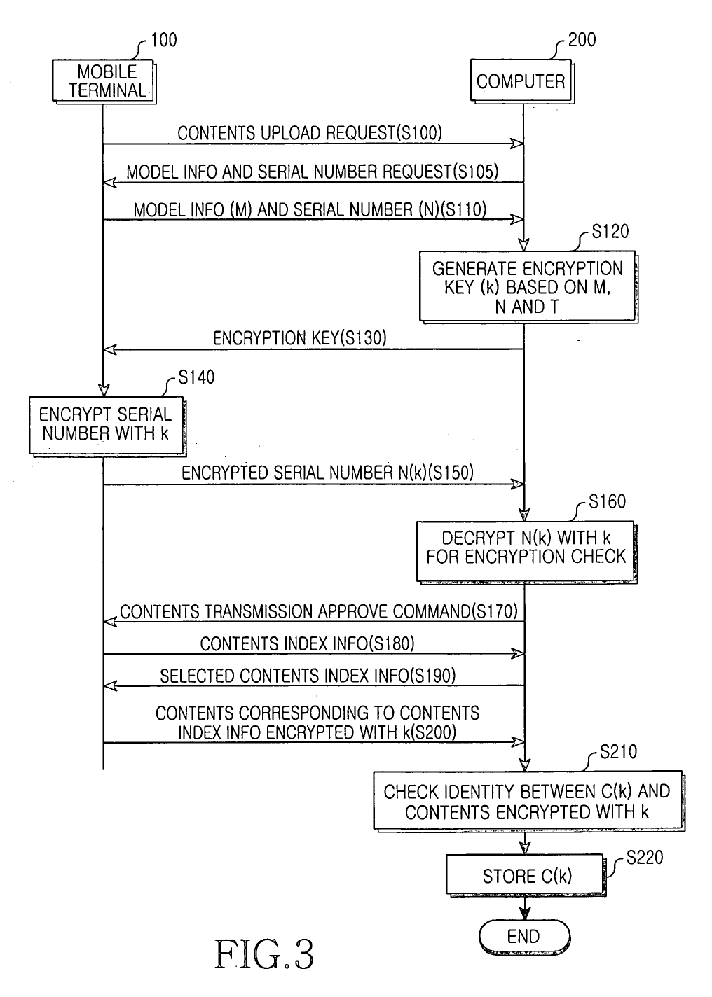

FIG. 3 is a flowchart illustrating a content protection method using a content security system according to an embodiment of the present invention. Referring to FIG. 3, if a content upload request signal for uploading content stored in the memory 160 is received using a prescribed key included in the key input unit 140, the controller 130 of the mobile terminal 100 transmits the received content upload request signal to the computer 200 via the wired communication unit 190 (Step S100). Upon receiving the content upload request signal from the mobile terminal 100, the CPU 210 of the computer 200 transmits a signal for requesting transmission of model information M and a serial number N of the mobile terminal 100, to the mobile terminal 100 via the interface 240 (Step S105).

Upon receiving the signal for requesting transmission of mobile information M and a serial number N, the controller 130 of the mobile terminal 100 transmits model information M and a serial number N of the mobile terminal 100, stored in the memory 160, to the computer 200 via the wired communication unit 190 (Step S10). Upon receiving the model information M and the serial number N of the mobile terminal 100, the CPU 210 of the computer 200 orders the encryption unit 260 to generate a unique encryption key k to be used by the mobile terminal 100 to encrypt content with the model information M and the serial number N of the mobile terminal 100 and time information T set in the computer 200. The encryption unit 260 then generates an encryption key k based on the model information M and the serial number N of the mobile terminal 100 and the time information T set in the computer 200 (Step S120). The CPU 210 transmits the encryption key k generated by the encryption unit 260 to the mobile terminal 100 via the interface 240 (Step S130).

It is preferable for the encryption unit 260 of the computer 200 to generate an encryption key k considering time information set in the mobile terminal 100 as well as the time information T set in the computer 200. If the time information T set in the computer 200 is not identical to the time information set in the mobile terminal 100, it is preferable for the encryption unit 260 not to generate an encryption key k.

Upon receiving an encryption key k from the computer 200, the controller 130 of the mobile terminal 100 commands the encryption unit 170 to encrypt a serial number N of the mobile terminal 100 with the encryption key k. The encryption unit 170 then encrypts a serial number N of the mobile terminal 100 with the encryption key k (Step S140). The controller 130 transmits the serial number N(k) of the mobile terminal 100, encrypted by the encryption unit 170, to the computer 200 via the wired communication unit 190 (Step S150).

Upon receiving the encrypted serial number N(k) of the mobile terminal 100 transmitted from the mobile terminal 100, the CPU 210 orders the decryption unit 270 to decrypt the received encrypted serial number N(k) (Step S160). The decryption unit 270 then decrypts the encrypted serial number N(k) with an encryption key k. The CPU 210 determines, based on the decrypted serial number, whether the mobile terminal 100 has properly encrypted its serial number N with the encryption key k. If it is determined that the mobile terminal 100 has properly encrypted its serial number N using the encryption key k, the CPU 210 transmits a content transmission approve command to the mobile terminal 100 via the interface 240 (Step S170).

The controller 130 of the mobile terminal 100 transmits content index information for the content stored in the memory 160 upon receiving the content transmission approve command (Step S180). For example, the content index information includes type, title, and file format of the content. The CPU 210 of the computer 200 displays the received content index information on its screen through the input/output unit 250, and if a particular one of the displayed content index information is selected, the CPU 210 transmits the selected content index information to the mobile terminal 100 via the interface 240 (Step S190).

Upon receiving the content index information, the controller 130 of the mobile terminal 100 reads content corresponding to the received content index information from the memory 160, and commands the encryption unit 170 to encrypt the read content. The encryption unit 170 then encrypts the content provided from the controller 130 using the encryption key k. The controller 130 transmits the encrypted content C(k) to the computer 200 via the wired communication unit 190 (Step S200).

The CPU 210 of the computer 200 orders the decryption unit 270 to decrypt the received encrypted content C(k), in order to determine whether the encrypted content C(k) received via the interface 240 is identical to the content encrypted with the encryption key k generated by the encryption unit 260 (Step S210). If it is determined that the content decrypted by the decryption unit 270 is identical to the content encrypted by the encryption key k, the CPU 210 stores the content C(k) encrypted by the encryption key k in the auxiliary memory device 280 (Step S220).

To sum up, the content stored in the mobile terminal 100 is encrypted with an encryption key k generated by the computer 200 based on model information M and a serial number N of the mobile terminal 100 and time information T set in the computer 200, and then uploaded to the computer 200. As a result, the computer 200 can prevent an unauthorized mobile terminal from downloading encrypted content C(k) stored in the computer 200 and decrypting the encrypted content C(k). In this way, it is possible to restrict a right to use the content.

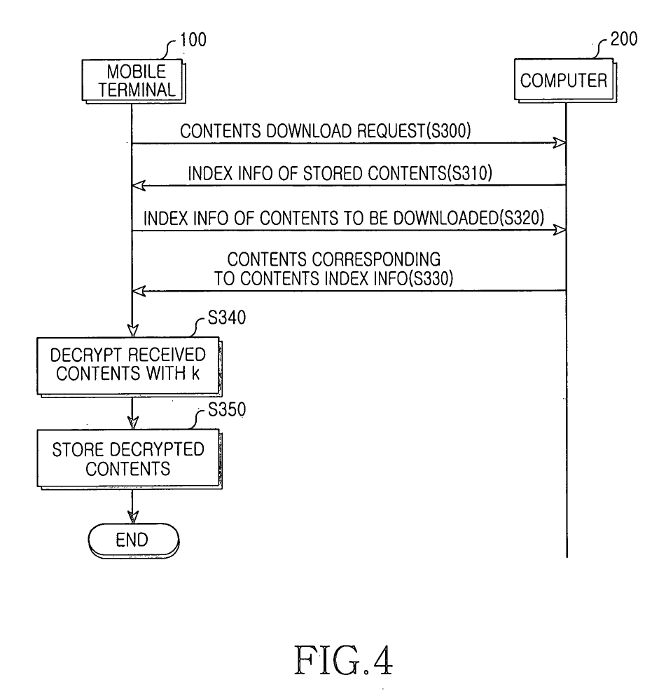

FIG. 4 is a flowchart illustrating a procedure for downloading the content uploaded by the procedure of FIG. 3. Referring to FIG. 4, upon receiving a content download request signal from the key input unit 140, the controller 130 of the mobile terminal 100 transmits the content download request signal to the computer 200 via the wired communication unit 190 (Step S300). The CPU 210 of the computer 200 transmits content index information stored in the auxiliary memory device 280 to the mobile terminal 100 via the interface 240 (Step S310).

If any download select signal is detected from the content index information received from the computer 200, the controller 130 of the mobile terminal 100 transmits the received index information of the content to be downloaded to the computer 200 via the wired communication unit 190 (Step S320). The CPU 210 of the computer 200 reads content corresponding to the received index information of the content to be downloaded from the auxiliary memory device 280, and transmits the read content to the mobile terminal 100 via the interface 240 (Step S330).

Upon receiving the content transmitted from the computer 200, the controller 130 of the mobile terminal 100 commands the decryption unit 180 to decrypt the received content (Step S340). The decryption unit 180 then decrypts the received content using the encryption key k stored in the memory 160. Thereafter, the controller 130 stores the decrypted content in the memory 160 (Step S350).

As can be understood from the foregoing description, a mobile terminal can decrypt downloaded content only with the encryption key k used during uploading of the corresponding content. In this manner, it is possible to limit a right to use the content and protect a copyright on the content.

Summarizing, content is encrypted using an encryption key provided from an external memory device before being uploaded to the external memory device, so only the mobile terminal that has uploaded corresponding content to the external memory device can download the corresponding content, thereby maintaining security for the content. In addition, a mobile terminal is provided with content from an external memory device in response to a content download request, and decrypts the received content with the encryption key k used for encryption during uploading of the corresponding content, thereby limiting a right to use the content.

Furthermore, since a content download request signal includes model information M and a serial number N of a mobile terminal, an external memory device determines whether the download-requested content is identical to the content previously uploaded by the mobile terminal, and transmits the corresponding content to the mobile terminal only when they are identical to each other. In this way, it is possible to protect a copyright on the content.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A mobile terminal for accessing a content server by wired and/or wireless communication, downloading content from the content server, and uploading the downloaded content to an external device, comprising:
a memory for storing model information and a serial number of the mobile terminal and the downloaded content, and also for storing an encryption key for encrypting the content downloaded from the external device;
a communication unit for providing an interface for exchanging data with the external device;
an encryption unit for encrypting the serial number and the content with the encryption key;
a controller for uploading the encrypted content to the external device via the communication unit, and for transmitting a download request signal for the uploaded content to the external device in response to an input command; and
a decryption unit for decrypting, with the encryption key, the content downloaded from the external device in response to the download request signal for the uploaded content.

2. The mobile terminal of claim 1, wherein the encryption key is generated by the external device based on the model information and the serial number of the mobile terminal.

3. The mobile terminal of claim 2, wherein the encryption key is generated by the external device considering further time information set in the external device.

4. A content security system comprising:
a mobile terminal for encrypting content provided from a content server with an encryption key provided from an external device, and for uploading the encrypted content to the external device; and
an external memory device for generating the encryption key based on model information and a serial number of the mobile terminal, and storing the encrypted content uploaded from the mobile terminal.

5. The content security system of claim 4, wherein the external memory device generates the encryption key considering further time information set in the external memory device.

6. The content security system of claim 5, wherein the external memory device determines whether the time information set in the external memory device is identical to time information set in the mobile terminal, and generates the encryption key if the time information set in the external memory device is identical to time information set in the mobile terminal.

7. The content security system of claim 4, wherein the mobile terminal transmits a download request signal for previously uploaded content to the external memory device in response to an input command, and decrypts, with the encryption key, content downloaded from the external memory device in response to the download request signal.

8. A content protection method using a content security system having a mobile terminal for downloading content from a content server and an external memory device for storing the content at a request of the mobile terminal, the method comprising the steps of:
transmitting a content upload request signal to the external memory device in response to an input command;
transmitting to the external memory device model information and a serial number of the mobile terminal, requested by the external memory device in response to the content upload request signal;
encrypting content to be uploaded with an encryption key generated by the external memory device based on the model information and the serial number; and
transmitting the content encrypted by the encryption key to the external memory device.

9. The content protection method of claim 8, further comprising the steps of:
determining whether the encrypted content uploaded from the mobile terminal is identical to the content encrypted by the encryption key; and
storing the encrypted content on the external memory device if the encrypted content uploaded from the mobile terminal is identical to the content encrypted by the encryption key.

10. The content protection method of claim 9, further comprising the steps of:
upon receiving a download command for the previously uploaded content, transmitting a content download request signal to the external memory device;
if content index information for downloading is selected from content index information provided from the external memory device in response to the content download request signal, transmitting the selected content index information to the external memory device;
if encrypted content is downloaded from the external memory device according to the selected content index information, decrypting the downloaded encrypted content with the encryption key.

11. The content protection method of claim 8; wherein the encryption key is generated by the external memory device considering further time information set in the external memory device.

12. The content protection method of claim 11, wherein the encryption key is generated when time information set in the external memory device is identical to time information set in the mobile terminal.
